(19) United States
(12) Patent Application Publication
(10) Pub. No.: US 2014/0021774 A1
(43) Pub. Date: Jan. 23, 2014

(54) WHEEL HUB STRUCTURE OF A BICYCLE

(71) Applicant: Bin Chang, Taichung City (TW)

(72) Inventor: Bin Chang, Taichung City (TW)

(21) Appl. No.: 13/615,613

(22) Filed: Sep. 14, 2012

(30) Foreign Application Priority Data
Jul. 18, 2012 (TW) 101125936

(51) Int. Cl. B60B 27/00

(52) U.S. Cl. CPC B60B 27/00
USPC 301/105.1

(57) ABSTRACT

A wheel hub structure of a bicycle includes a wheel hub having a first hub body, a second hub body, a shrink ring, and a ratchet base. The shrink ring could be assembled between the first hub body and the second hub body or between the second hub body and ratchet base. Therefore, the length of the wheel hub or the ratchet base could be increased.

### BACKGROUND OF THE INVENTION

1. Field of the Invention

The present invention relates to a wheel hub and more particularly to a wheel hub structure of a bicycle.

2. Description of Related Art

Bicycle activity is more and more popular in these days because bicycle activity is eco-friendly, convenient and entertaining. Many enterprises encourage their employees to go to work by bicycles instead of driving vehicles today. Many people also go shopping or go traveling by bicycles during their leisure time. Because a wheel hub of a bicycle is very important for the comfort of riding, the improvement of the wheel hub structure is continuously progressed.

The sequence for driving a bicycle is that when a rider treads on the pedals of a bicycle, one of chain wheels with different sizes will drive one of freewheels with different sizes via a drive chain, so that the wheel hub is driven by the freewheel to drive the bicycle move forward. In addition, a derailleur system is further assembled onto the wheel hub so as to allow a speed-change.

The speed-change is described as following. The derailleur system of the bicycle allows a shift in a gear ratio, which is based on a gradient of the road. The gear ratio is defined by a number of teeth on the chain wheel, which is divided by another number of teeth on the freewheel. When the rider rides on a downgrade road, the derailleur system is shifted to be under higher gear ratio so that the rider would rides safely. Conversely, when the rider rides on an upgrade road, the derailleur system is shifted to be under lower gear ratio so that the rider would rides easily. For the derailleur system, because the gradient of the road is various, the amount of the freewheels with different sizes, which are assembled on the wheel hub, would be increased by a manufacturer for defining various gear ratios.

Referring to FIG. 9, the conventional wheel hub structure comprises a wheel hub 4 and a ratchet base 5a. The ratchet base 5a is mounted at one end of the wheel hub 4. The wheel hub 4 has a first hub plate 41 and a second hub plate 42 which are respectively extruded around two ends thereof. The second hub plate 42 is close to the ratchet base 5a. A distance is defined between the first hub plate 41 and the second hub plate 42. A plurality of spokes 6 is uniformly assembled around the first hub plate 41 and the second hub plate 42 at one end thereof. Another end of each spoke 6 is assembled to a wheel frame (not shown). A plurality of freewheels 7a sleeves onto the ratchet base 5a. Thereby, when the rider treads on the pedals of a bicycle, the wheel hub 4 drives the wheel frame to rotate via the spokes 6.

Referring to FIG. 9, when ten freewheels 7a are mounted on the ratchet base 5a, a distance A1 between the first hub plate 41 and a gravity center w3 of the wheel hub 4 with the ratchet base 5a is 35 mm; another distance B1 between the second hub plate 42 and the gravity center w3 is 19 mm (in the present prior art, the length of the wheel hub is 54 mm). Wherein, the position of the gravity center w3 allows the connection between the spoke 6, the first hub plate 41 and the second hub plate 42 to be stable, so that the wheel frame can rotate stably.

Referring to FIG. 10, however, when eleven freewheels 7b are mounted on a further ratchet base 5b, a further distance A2 between the first hub plate 41 and a gravity center w4 of the wheel hub 4 with the further ratchet base 5b is 37 mm; another further distance B2 between the second hub plate 42 and the gravity center w4 is 17 mm. A length of the ratchet base 5a is corresponding to the amount of the freewheels 7a, and another length of the further ratchet base 5b is corresponding to the amount of the freewheels 7b. Wherein, the position of the gravity center w4 does not allow the connection between the spoke 6, the first hub plate 41 and the second hub plate 42 to be stable, because a tension of the spokes 6 which is mounted in the second hub plate 42 is not enough and another tension of the spokes 6 which is mounted in the first hub plate 41 is too much. Thus, the wheel frame cannot rotate stably, so that the wheel frame would be vibrated during riding and the spokes 6 would be deformed after long-term use.

Furthermore, when the user wants to replace ten freewheels 7a with eleven freewheels 7b, the user must also replace the ratchet base 5a with the further ratchet base 5b, because the length of the ratchet base 5a is corresponding to the amount of the freewheels 7a, and another length of the further ratchet base 5b is corresponding to the amount of the freewheels 7b. Therefore, it is not only inconvenient for the user to replace the ratchet base 5a with the further ratchet base 5b, but also spending much money on the further ratchet base 5b.

The present invention has arisen to mitigate and/or obviate the disadvantages of the conventional. Further benefits and advantages of the present invention will become apparent after a careful reading of the detailed description with appropriate reference to the accompanying drawings.

### SUMMARY OF THE INVENTION

The main objective of the present invention is to provide an improved driving structure.

To achieve the objective, a wheel hub structure of a bicycle comprises a wheel hub having a first hub body, a second hub body, a shrink ring, a ratchet base with a freewheel set, the first hub body having a first connecting portion defined at one end thereof, the second hub body having a second connecting portion defined at one end thereof, the second connecting portion of the second hub body corresponding to the first connecting portion of the first hub body, and the shrink ring sleeving onto the second connecting portion of the second hub body, the ratchet base mounted at another end of the second hub body. Wherein, a length of the first hub body is longer than another length of the second hub body; an axial length of the second connecting portion of the second hub body is longer than another axial length of the shrink ring; the second connecting portion of the second hub body has a plurality of engaging portions defined around an outer periphery thereof; the shrink ring has an opening opened thereon; the opening has a plurality of engaging grooves; each engaging groove is corresponding to each corresponding engaging portion; each engaging portion is engaged with each corresponding engaging groove.

Therefore, the shrink ring sleeves onto the second connecting portion of the second hub body; and then the second connecting portion of the second hub body is inserted into the first connecting portion of the first hub body; as a result, the shrink ring is located between the first hub body and the second hub body and is abutted against the first connecting portion of the first hub body, so that a length of the wheel hub is increased; when the freewheel set is mounted on the ratchet base, a gravity center of the wheel hub is located at a suitable position, so that two sides of the wheel hub are balanced with each other.

A wheel hub structure of a bicycle of the second embodiment of the present invention comprises a wheel hub having a first hub body, a second hub body, a shrink ring and a ratchet base with a freewheel set, the first hub body assembled to one end of the second hub body, the second hub body having a receiving portion defined at another end thereof, the ratchet base having an inserting portion defined at one end thereof, the ratchet base having a plurality of insertion grooves defined around an outer periphery thereof, the inserting portion of the ratchet base inserted into the receiving portion of the second hub body, and the shrink ring having a plurality of axial grooves, each axial groove corresponding to each corresponding insertion groove of the ratchet base, the shrink ring sleeving on the inserting portion of the ratchet base, so that the shrink ring is located between the ratchet base and the second hub body. Wherein, a length of the first hub body is longer than another length of the second hub body; an axial length of the inserting portion of the ratchet base is longer than another axial length of the shrink ring; an assembling method for assembling the first hub body to the second hub body, and another assembling method for assembling the second hub body, the ratchet base and the shrink ring to each other could be screwing, buckling or sleeving.

Therefore, the shrink ring sleeves onto the inserting portion of the ratchet base; and then, the ratchet base is inserted into the receiving portion of the second hub body; as a result, the shrink ring is located between the second hub body and the ratchet base and is abutted against the receiving portion, so that the length of the wheel hub is increased; when the freewheel set is mounted on the ratchet base, a gravity center of the wheel hub is located at a suitable position, so that two sides of the wheel hub are balanced with each other.

Further benefits and advantages of the present invention will become apparent after a careful reading of the detailed description with appropriate reference to the accompanying drawings.

### BRIEF DESCRIPTION OF THE DRAWINGS

FIG. 1 is an exploded view of a wheel hub structure of a bicycle of the first embodiment of the present invention;

FIG. 2 is a perspective view of the wheel hub structure of a bicycle of the first embodiment;

FIG. 3 is a side view of the wheel hub structure of a bicycle of the first embodiment;

FIG. 4 is an assembled view of the wheel hub structure of a bicycle of the first embodiment;

FIG. 5 is a perspective view of a wheel hub structure of a bicycle of the second embodiment;

FIG. 6 is an exploded view of the wheel hub structure of a bicycle of the second embodiment;

FIG. 7 is a side view of the wheel hub structure of a bicycle of the second embodiment;

FIG. 8 is an assembled perspective view of the wheel hub structure of a bicycle of the second embodiment;

FIG. 9 is an assembled perspective view of a conventional wheel hub structure of a bicycle; and

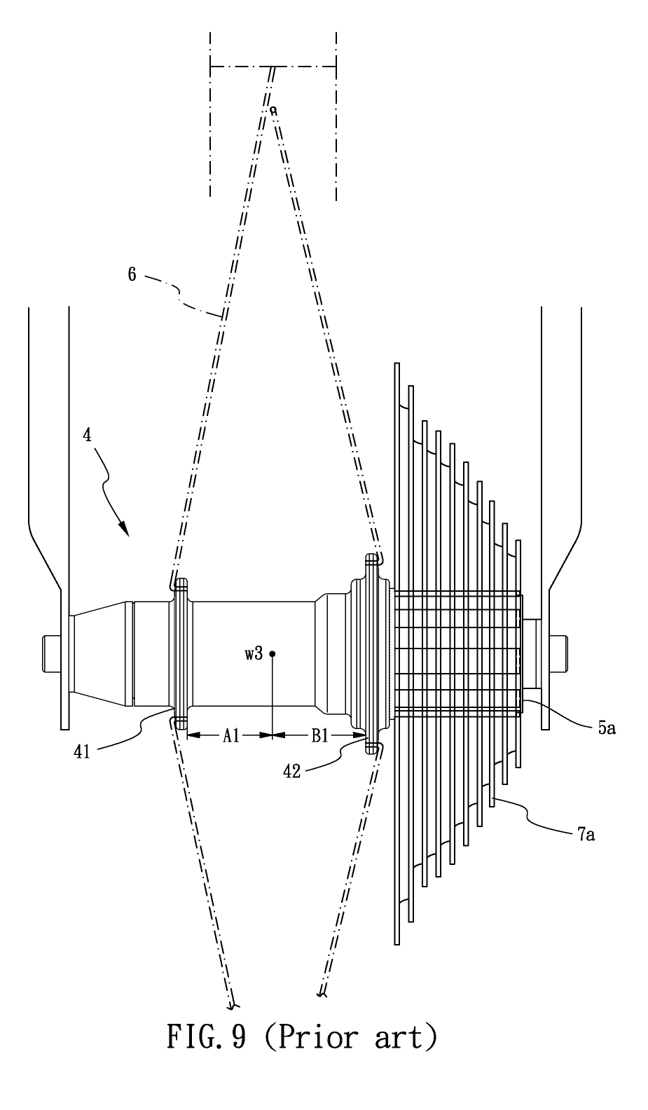

FIG. 10 is another assembled perspective view of a conventional wheel hub structure of a bicycle.

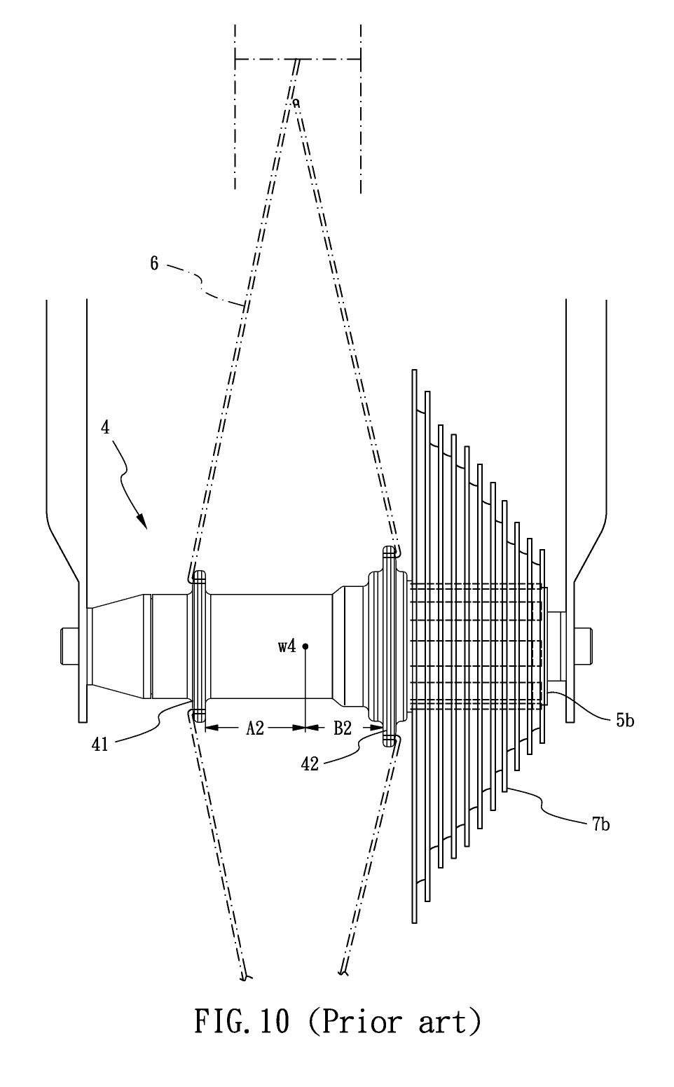

### DETAILED DESCRIPTION OF THE INVENTION

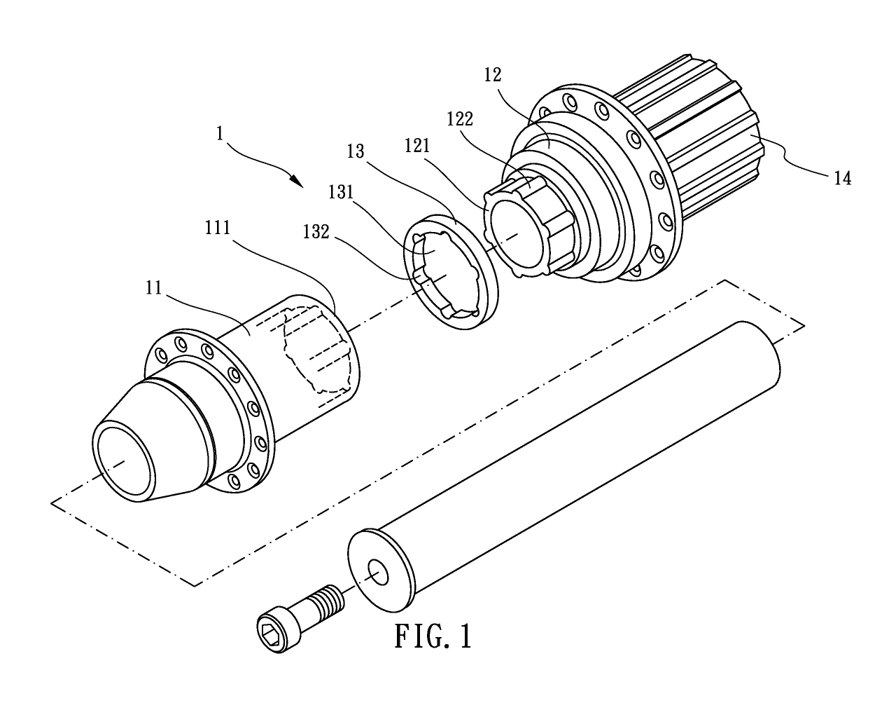

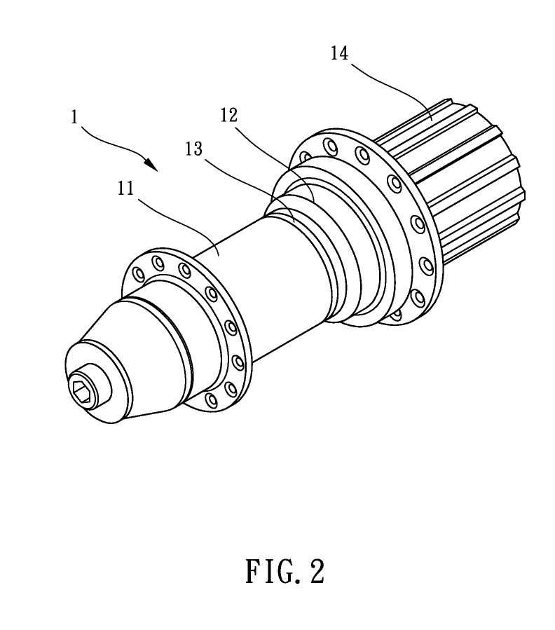

Referring to FIGS. 1-4, that shows a first embodiment of a wheel hub structure of a bicycle in accordance with the present invention. The wheel hub structure of a bicycle in accordance with the present invention comprises a wheel hub 1.

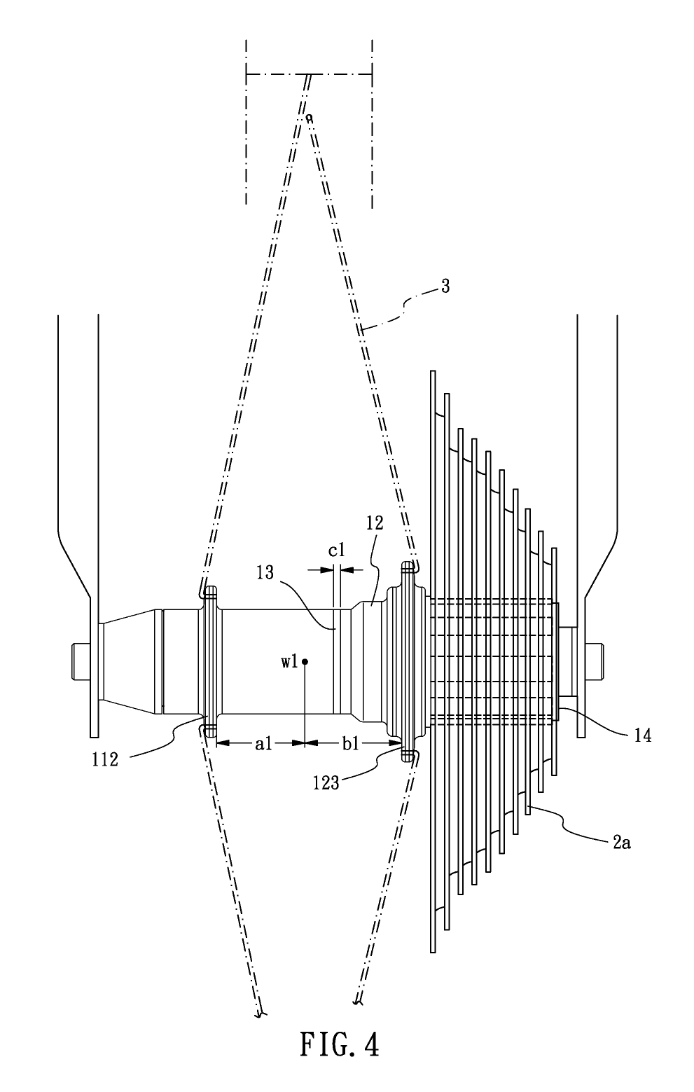

The wheel hub 1 has a first hub body 11, a second hub body 12, a shrink ring 13, a ratchet base 14 with a freewheel set 2a (in the first embodiment, the freewheel set 2a has ten freewheels as shown in FIG. 4). The first hub body 11 has a first connecting portion 111 defined at one end thereof. The second hub body 12 has a second connecting portion 121 defined at one end thereof. The second connecting portion 121 of the second hub body 12 is corresponding to the first connecting portion 111 of the first hub body 11. The shrink ring 13 sleeves onto the second connecting portion 121 of the second hub body 12. The ratchet base 14 is mounted at another end of the second hub body 12.

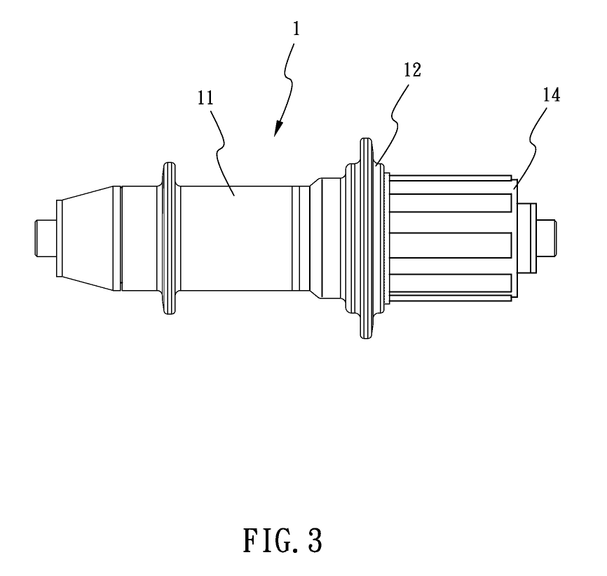

Under this arrangement, the shrink ring 13 sleeves onto the second connecting portion 121 of the second hub body 12; and then the second connecting portion 121 of the second hub body 12 is inserted into the first connecting portion 111 of the first hub body 11; as a result the shrink ring 13 is located between the first hub body 11 and the second hub body 12 and is abutted against the first connecting portion 111 of the first hub body 11, so that a length of the wheel hub 1 is increased (as shown in FIG. 3). When the freewheel set 2a is mounted on the ratchet base 14, a gravity center w1 of the wheel hub 1 is located at a suitable position, so that two sides of the wheel hub 1 are balanced with each other (as shown in FIG. 4).

Referring to FIG. 1-4, the first embodiment of the present invention has the following characteristics:

1. A length of the first hub body 11 is longer than another length of the second hub body 12.

2. An axial length of the second connecting portion 121 of the second hub body 12 is longer than another axial length of the shrink ring 13. After the shrink ring 13 sleeves onto the second connecting portion 121 of the second hub body 12, the shrink ring 13 is abutted against the second hub body 12 of the wheel hub 1; as a result, the second connecting portion 121 which is exposed from the shrink ring 13 is inserted into the connecting portion 111 of the first hub body 11.

3. The second connecting portion 121 of the second hub body 12 has a plurality of engaging portions 122 defined around an outer periphery thereof. The shrink ring 13 has an opening 131 opened thereon. The opening 131 has a plurality of engaging grooves 132. Each engaging groove 132 is corresponding to each corresponding engaging portion 122. Each engaging portion 122 is engaged with each corresponding engaging groove 132. Thereby, the shrink ring 13 is securely connected to the second hub body 12 and is rotated by the rotation of the second hub body 12, when the wheel hub 1 is rotated.

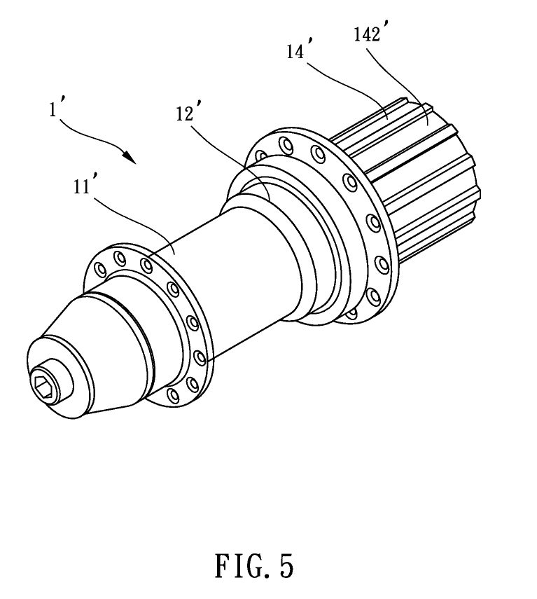

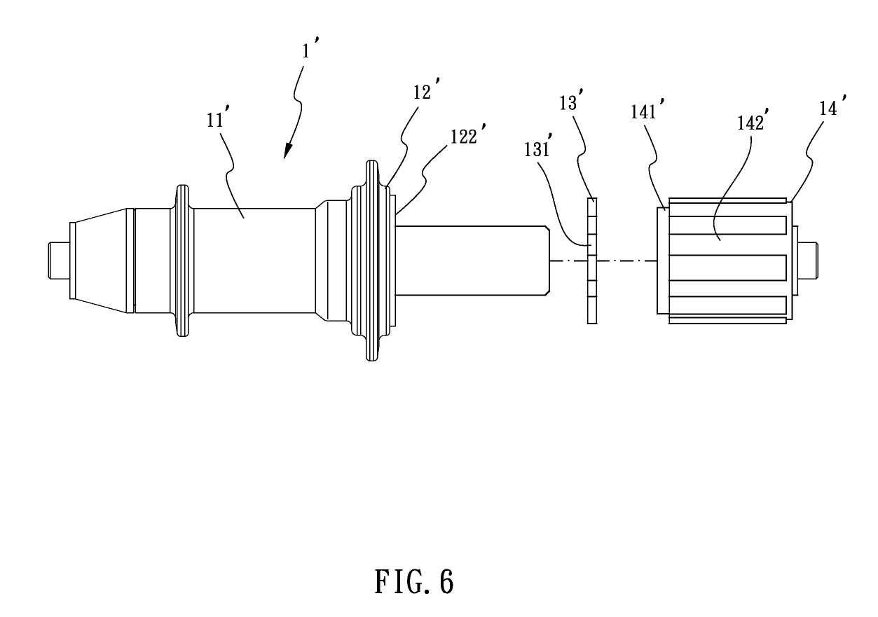

Referring to FIGS. 5-8, that shows a second embodiment of the present invention. A wheel hub structure of a bicycle in accordance with the present invention comprises a wheel hub 1′.

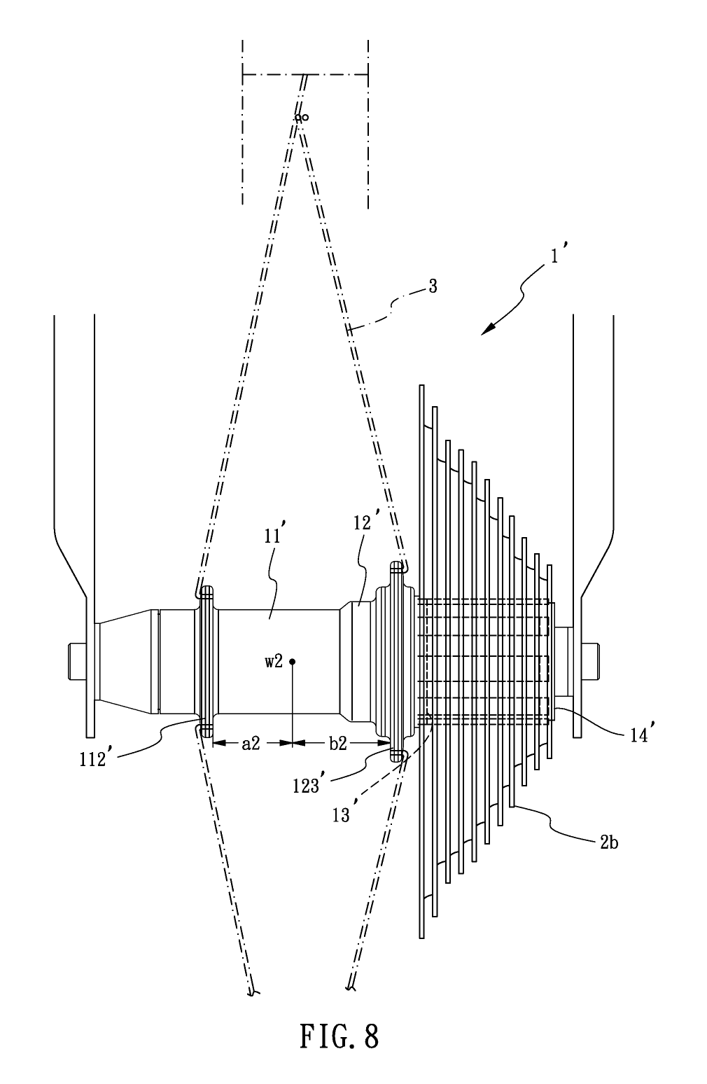

The wheel hub 1′ has a first hub body 11′, a second hub body 12′, a shrink ring 13′ and a ratchet base 14′ with a freewheel set 2b (in the second embodiment, the freewheel set 2b has eleven freewheels as shown in FIG. 8). The first hub body 11′ is assembled to one end of the second hub body 12′. The second hub body 12′ has a receiving portion 122′ defined at another end thereof. The ratchet base 14′ has an inserting portion 141′ defined at one end thereof. The ratchet base 14′ has a plurality of insertion grooves 142′ defined around an outer periphery thereof. The inserting portion 141′ of the ratchet base 14′ is inserted into the receiving portion 122′ of the second hub body 12′. The shrink ring 13′ has a plurality of axial grooves 131′. Each axial groove 131′ is corresponding to each corresponding insertion groove 142′ of the ratchet base 14′. The shrink ring 13′ sleeves on the inserting portion 141′ of the ratchet base 14′, so that the shrink ring 13′ located between the ratchet base 14′ and the second hub body 12′.

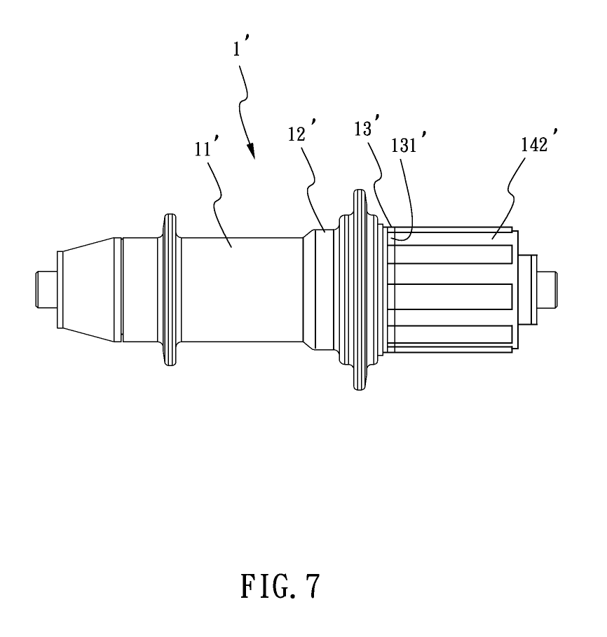

Under this arrangement, the shrink ring 13′ sleeves onto the inserting portion 141′ of the ratchet base 14′; and then, the ratchet base 14′ is inserted into the receiving portion 122′ of the second hub body 12′; as a result the shrink ring 13′ is located between the second hub body 12′ and the ratchet base 14′ and is abutted against the receiving portion 122′, so that the length of the wheel hub 1′ is increased (as shown in FIG. 7). Thus the freewheel set 2b is able to be positioned on the ratchet base 14′ and the shrink ring 13′. When the freewheel set 2b is mounted on the ratchet base 14′, a gravity center w2 of the wheel hub 1′ is located at a suitable position, so that two sides of the wheel hub 1′ are balanced with each other (as shown in FIG. 4).

Referring to FIG. 5-8, the second embodiment of the present invention has the following characteristics:

1. A length of the first hub body 11′ is longer than another length of the second hub body 12′.

2. An axial length of the inserting portion 141′ of the ratchet base 14′ is longer than another axial length of the shrink ring 13′. After the shrink ring 13′ sleeves onto the inserting portion 141′, the shrink ring 13′ is abutted against the ratchet base 14′ of the wheel hub 1′; as a result, the inserting portion 141′ which is exposed from the shrink ring 13′ is inserted into the receiving portion 122′ of the second hub body 12′.

3. An assembling method for assembling the first hub body 11′ to the second hub body 12′, and another assembling method for assembling the second hub body 12′, the ratchet base 14′ and the shrink ring 13′ to each other could be screwing, buckling or sleeving.

Referring to the FIG. 4 and FIG. 8, that shows a coordination of the first embodiment and the second embodiment, in which the shrink ring 13 of the first embodiment is coordinated with the shrink ring 13′ of the second embodiment.

Referring to the FIG. 4, that shows the first embodiment. The first hub body 11 has a first hub plate 112 extruded around one end thereof. The second hub body 12 has a second hub plate 123 extruded around one end thereof. A plurality of spokes 3 is uniformly assembled around the first hub plate 112 and the second hub plate 123 at one end thereof. Another end of each spokes is assembled to a wheel frame (not shown). When the freewheel set 2a with ten freewheels is assembled to the ratchet base 14 of the wheel hub 1, the shrink ring 13 is assembled between the first hub body 11 and the second hub body 12, wherein a distance a1 between the first hub plate 112 and a gravity center w1 of the wheel hub 1 is 35 mm; another distance b1 between the second hub plate 123 and the gravity center w1 is 19 mm. As a result, the position of the gravity center w1 allows the connection between the spoke 3, the first hub plate 112 and the second hub plate 123 to be stable, so that the wheel frame can rotate stably.

Referring to the FIG. 8, when a user wants to replace the freewheel set 2a with the freewheel set 2b on the ratchet base 14′, the shrink ring 13′ should be further assembled to the ratchet base 14′ so as to increase an axial length of the ratchet base 14′, because a further axial length of the freewheel set 2b is longer than another further axial length of the freewheel set 2a. As a result, the gravity center w1 would be shifted to the gravity center w2 (as shown in FIG. 8); a distance between the second hub plate 123 and the gravity center w2 is 17 mm an another distance between the first hub plate 112 and the gravity center w2 is 37 mm. Therefore, the position of the gravity center w2 cannot allow the connection between the spoke 3, the first hub plate 112 and the second hub plate 123 to be stable as the gravity center w1.

In order to shift the gravity center w2 back to the gravity center w1, the user removes the shrink ring 13 between the first hub body 11 and the second hub body 12; as a result, the gravity center w2 is shifted back to the gravity center w1. In addition, the distance b2 is shift back to the distance b1; and the distance a2 is shift back to the distance a1. Thereby, even though the freewheel set 2b is mounted on the ratchet base 14′, the position of the gravity center w2 would be shifted back to the gravity center w1 which allows the connection between the spoke 3′, the first hub plate 112′ and the second hub plate 123′ to be stable, so that the wheel frame can rotate stably.

Although the invention has been explained in relation to its preferred embodiment, it is to be understood that many other possible modifications and variations can be made without departing from the spirit and scope of the invention as hereinafter claimed.

What is claimed is:

1. A wheel hub structure of a bicycle comprising:
A wheel hub having a first hub body, a second hub body, a shrink ring, a ratchet base with a freewheel set;
the first hub body having a first connecting portion defined at one end thereof; the second hub body having a second connecting portion defined at one end thereof, the second connecting portion of the second hub body corresponding to the first connecting portion of the first hub body; and
the shrink ring sleeving onto the second connecting portion of the second hub body; the ratchet base mounted at another end of the second hub body;
wherein the shrink ring sleeves onto the second connecting portion of the second hub body; and then the second connecting portion of the second hub body is inserted into the first connecting portion of the first hub body; as a result, the shrink ring is located between the first hub body and the second hub body and is abutted against the first connecting portion of the first hub body, so that a length of the wheel hub is increased; when the freewheel set is mounted on the ratchet base, a gravity center of the wheel hub is located at a suitable position, so that two sides of the wheel hub are balanced with each other.

2. The wheel hub structure of a bicycle as claimed in claim 1, wherein a length of the first hub body is longer than another length of the second hub body.

3. The wheel hub structure of a bicycle as claimed in claim 1, wherein an axial length of the second connecting portion of the second hub body is longer than another axial length of the shrink ring.

4. The wheel hub structure of a bicycle as claimed in claim 1, wherein the second connecting portion of the second hub body has a plurality of engaging portions defined around an outer periphery thereof; the shrink ring has an opening opened thereon; the opening has a plurality of engaging grooves; each engaging groove is corresponding to each corresponding engaging portion; each engaging portion is engaged with each corresponding engaging groove.

5. A wheel hub structure of a bicycle comprising:
a wheel hub having a first hub body, a second hub body, a shrink ring and a ratchet base with a freewheel set;
the first hub body assembled to one end of the second hub body, the second hub body having a receiving portion defined at another end thereof;
the ratchet base having an inserting portion defined at one end thereof; the ratchet base having a plurality of insertion grooves defined around an outer periphery thereof; the inserting portion of the ratchet base inserted into the receiving portion of the second hub body; and
the shrink ring having a plurality of axial grooves; each axial groove corresponding to each corresponding insertion groove of the ratchet base; the shrink ring sleeving on the inserting portion of the ratchet base, so that the shrink ring is located between the ratchet base and the second hub body;
wherein the shrink ring sleeves onto the inserting portion of the ratchet base; and then, the ratchet base is inserted into the receiving portion of the second hub body; as a result, the shrink ring is located between the second hub body and the ratchet base and is abutted against the receiving portion, so that the length of the wheel hub is increased; when the freewheel set is mounted on the ratchet base, a gravity center of the wheel hub is located at a suitable position, so that two sides of the wheel hub are balanced with each other.

6. The wheel hub structure of a bicycle as claimed in claim 1, wherein a length of the first hub body is longer than another length of the second hub body.

7. The wheel hub structure of a bicycle as claimed in claim 1, wherein an axial length of the inserting portion of the ratchet base is longer than another axial length of the shrink ring.

8. The wheel hub structure of a bicycle as claimed in claim 1, wherein an assembling method for assembling the first hub body to the second hub body, and another assembling method for assembling the second hub body, the ratchet base and the shrink ring to each other could be screwing, buckling or sleeving.
